(19) United States
(12) Patent Application Publication
(10) Pub. No.: US 2020/0148438 A1
(43) Pub. Date: May 14, 2020

(54) MAGNETIC LOCKING CONTAINER

(71) Applicants: Adam Charles Brown, Carlsbad, CA (US); Nathan Lee Peters, Huntington Beach, CA (US); Brad Steven Zaikov, Cresskill, NJ (US)

(72) Inventors: Adam Charles Brown, Carlsbad, CA (US); Nathan Lee Peters, Huntington Beach, CA (US); Brad Steven Zaikov, Cresskill, NJ (US)

(21) Appl. No.: 16/184,484

(22) Filed: Nov. 8, 2018

(51) Int. Cl. B65D 50/06; A61J 1/03

(52) U.S. Cl. CPC B65D 50/06; A61J 1/03

(57) ABSTRACT

The present disclosure provides a container including a housing shell and an interior sleeve positioned within the housing shell. The housing shell can include a magnetic panel within one end, wherein the magnetic panel is positioned flush against at least one end of the interior sleeve. The position of the magnetic panel determines whether the container is in a locked or unlocked position. The interior sleeve can slide in and out of the housing shell when the container is in the unlocked position.

### BACKGROUND OF THE INVENTION

The present subject matter relates generally to a container system including a magnetic locking mechanism to access the interior of the container.

Many accidents, some of which are fatal, are traceable to unwary children who get hold of easy-to-open drug and medicine bottles and containers and swallow the contents. In addition to warnings and care exercised by parents and others, many containers attempt to include prevention of unauthorized use of the content insides.

For example, various designs for containers housing potent medicines and corrosive chemicals use various child-proofing mechanisms to prevent the interior materials out of the hands of children. Typically, child-proof medicine bottles and containers include a mechanical locking mechanism, such as a clutching mechanism. For example, a user must press down on the cap while turning the cap. Alternatively, the user may need to squeeze two sides of a cap while turning. As a result, most mechanical clutching variations are cumbersome and difficult for a variety of users to open (e.g., persons with arthritis, elderly, etc.).

Alternatively, tamper-proof medicine bottles and containers that do include a locking mechanism requiring the use of a key or memorized combination make unlocking the containers dependent on inconvenient external factors. For example, a user may lose the key or forget the combination code, requiring professional help to open the containers.

Accordingly, there is a need for a container including a locking mechanism that is simple, yet effective, without requiring a code or key for accessing.

### BRIEF SUMMARY OF THE INVENTION

The present disclosure provides a container system including a magnetic locking mechanism to access the interior of the container. Various examples of the system are provided herein.

The present disclosure provides a container including a housing shell and an interior sleeve positioned within the housing shell. The housing shell can include a magnetic panel within one end, wherein the magnetic panel is positioned flush against at least one end of the interior sleeve. The position of the magnetic panel determines whether the container is in a locked or unlocked position. The interior sleeve can slide in and out of the housing shell when the container is in the unlocked position.

The housing shell can include a top panel, a bottom panel, and two side panels connecting the top panel to the bottom panel. The interior sleeve can be in a “U” shape including an interior bottom panel and two interior side panels, wherein the interior sleeve can include a front panel and a back panel, wherein the front panel is magnetic.

The magnetic panel can include a first side and a second side, wherein at least the second side is magnetic. When the second side of the magnetic panel is adjacent to the front panel of the interior sleeve, the interior sleeve is locked within the housing shell. In the locked position, the container can be rotated and inverted without the interior sleeve falling out of the housing shell.

A user can remove the magnetic panel and/or flip the magnetic panel around such that the first side of the magnetic panel is placed adjacent to the front panel of the interior sleeve, thereby unlocking the container such that the interior sleeve can be at least partially removed from the housing shell. For example, when the first side of the magnetic panel is placed adjacent to the front panel of the interior sleeve, the interior sleeve can slide out of the housing shell.

An advantage of the present container is providing a locking mechanism that does not require a key or code to unlock.

A further advantage of the present container is providing a locking mechanism that is easy to use but effective against unauthorized use of its content.

Another advantage of the present container is providing a locking mechanism that is cost effective to manufacture due to minimal parts.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a perspective view of an example of the container disclosed herein wherein the second side of the magnetic panel is engaged with the front panel of the interior sleeve.

FIG. 2 is a perspective view of an example of the container disclosed herein wherein the magnetic panel is removed from engaging with the front panel of the interior sleeve.

FIG. 3 is a perspective view of an example of a user rotating the magnetic panel.

FIG. 4 is a perspective view of an example of a user replacing the magnetic panel such that the first side of the magnetic panel engages with the front panel of the interior sleeve.

FIG. 5 is a perspective view of an example of the container wherein the interior sleeve is unlocked from the housing shell, wherein the interior sleeve slides out of the housing shell exposing the interior cavity of the interior sleeve.

### DETAILED DESCRIPTION OF THE INVENTION

The present disclosure provides a container system including a magnetic locking mechanism to access the interior of the container. Various examples of the system are provided herein.

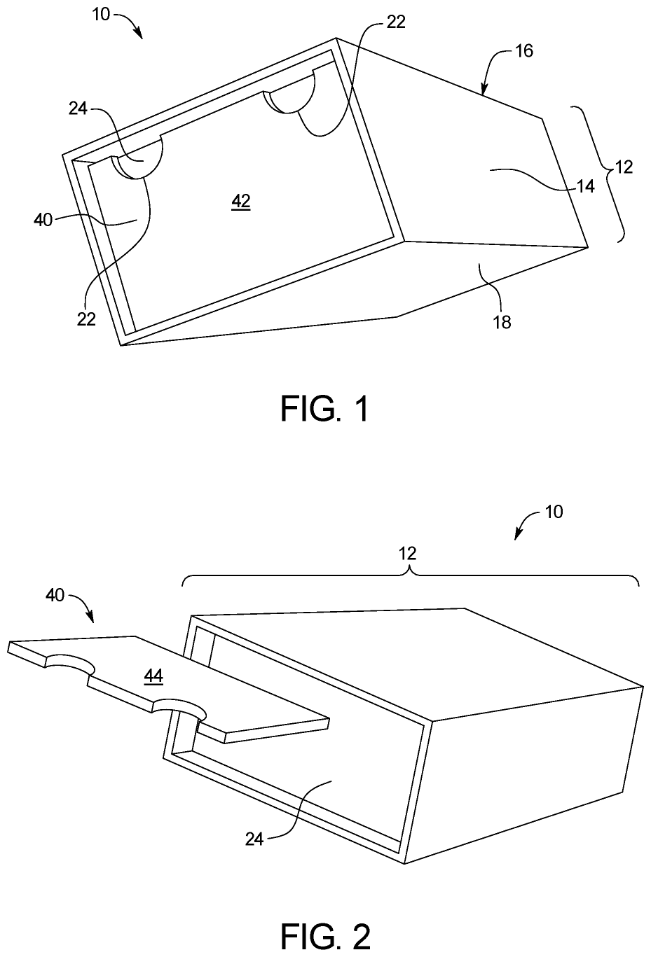

As shown in FIG. 1, the container 10 disclosed herein includes a housing shell 12 and an interior sleeve 20. The housing shell 12 can include a top panel 16, a bottom panel 18, and two side panels 14 connecting the top panel 16 to the bottom panel 18. Alternatively, the housing shell 12 could be any suitable shape, including a circular cylinder, triangular cylinder, octagon cylinder, among others.

The interior sleeve 20 can be in a “U” shape including an interior bottom panel and two interior side panels 30. The interior sleeve 20 can include a front panel 24 and a back panel 26.

The container 10 includes a magnetic panel 40 including a first side 42 and a second side 44, wherein the magnetic panel 40 can be replaceably positioned within a first end of the housing shell 12. The position of the magnetic panel 40 determines whether the container is in a locked or unlocked position.

When the second side 44 of the magnetic panel 40 is adjacent to the front panel 24 of the interior sleeve 20, the interior sleeve 20 is locked within the housing shell 12. In the locked position, the container 10 can be rotated and inverted without the interior sleeve 20 falling out of the housing shell 12.

When the second side 44 of the magnetic panel 40 is not adjacent to the front panel 24 of the interior sleeve 20, interior sleeve 20 can slide in and out of the housing shell 12 of the container 10.

As shown in FIG. 2, the magnetic panel 40 can be removed from being adjacent to the front panel 24 by the user. In an example, a user can remove the magnetic panel 40 using at least one finger opening portion 22 along at least one edge of the magnetic panel. The finger opening portion 22 is a void or cut-out within the magnetic panel 40, wherein a user can insert a portion of a finger to pry the magnetic panel 40 away from the front panel 24. Alternatively, the user can remove the magnetic panel 40 by any suitable mechanism.

In an example, when the first side 44 of the magnetic panel 40 is removed from the front panel, the interior sleeve 20 can slide out of the housing shell 12. In an example, when the first side 44 of the magnetic panel 40 is placed adjacent to the front panel 24 of the interior sleeve 20, the interior sleeve 20 can slide out of the housing shell 12.

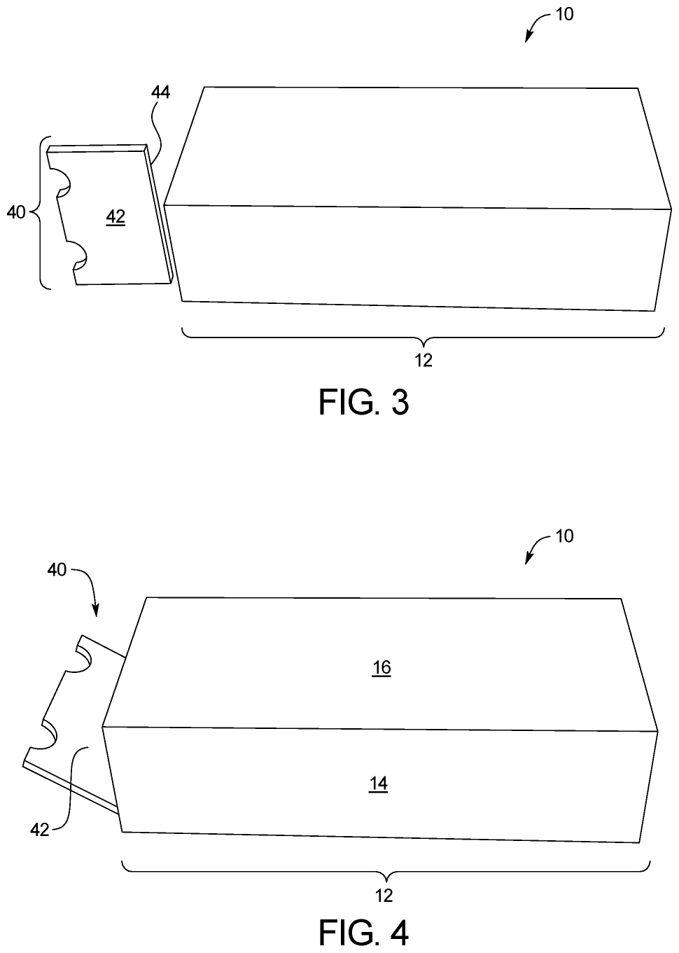

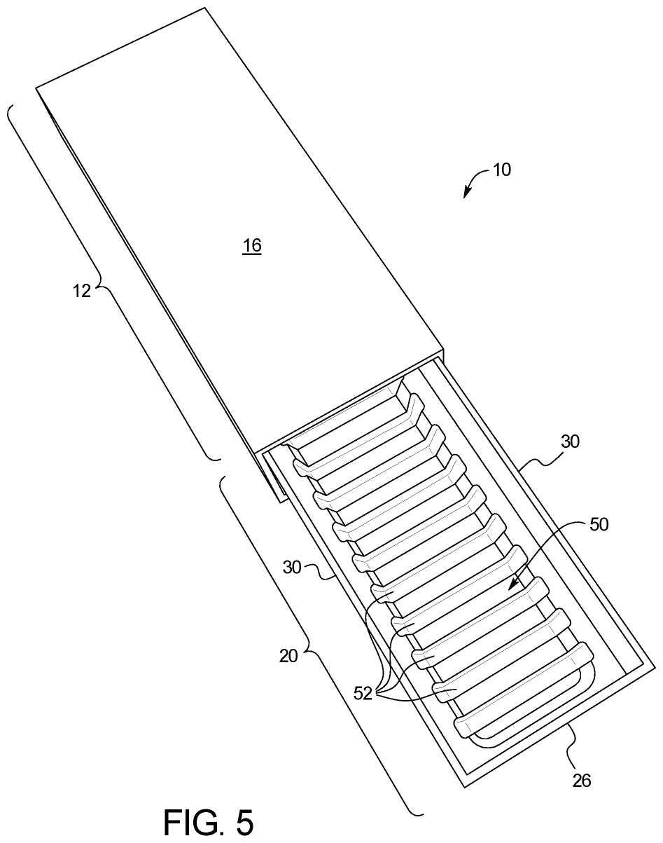

As shown in FIGS. 3-5, the user can flip the magnetic panel 40 around so that the first side 44 of the magnetic panel 40 is placed adjacent to the front panel 24 of the interior sleeve 20, thereby unlocking the container 10 such that the interior sleeve 20 can be at least partially removed from the housing shell 12.

In an example, the second side 42 of the magnetic panel 40 does include a magnetic source and the first side 44 of the magnetic panel 40 does not include a magnetic source, wherein the polarity of the magnet in the second side 42 is opposite of the polarity of the front panel 24 of the interior sleeve 20. As a result, the front panel 24 of the interior sleeve 20 is attracted to the second side 44 and not attracted by the first side 42 of the magnetic panel 40. Therefore, when the second side 44 of the magnetic panel 40 is adjacent to the front panel 24 of the interior sleeve 20, the attraction between the second side 44 of the magnetic panel 40 and the front panel 24 of the interior sleeve 20 prevents the interior sleeve 20 from sliding out of the housing shell 12. However, when the magnetic panel 40 is removed and/or flipped around such that the first side 42 of the magnetic panel 40 is adjacent to the front panel 24 of the interior sleeve 20, the interior sleeve 20 is not held in place by the magnetic force enabling the interior sleeve 20 to slide out of the housing shell 12.

In an example, the first side 42 and the second side 44 of the magnetic panel 40 can include magnetic sources, wherein the polarity of the first side 42 is opposite of that of the second side 44. The front panel 24 of the interior sleeve 20 can include a magnetic source that is attracted to the second side 44 and repelled by the first side 42 of the magnetic panel 40. As a result, when the second side 44 of the magnetic panel 40 is adjacent to the front panel 24 of the interior sleeve 20, the attraction between the second side 44 of the magnetic panel 40 and the front panel 24 of the interior sleeve 20 prevents the interior sleeve 20 from sliding out of the housing shell 12. However, when the magnetic panel 40 is flipped around such that the first side 42 of the magnetic panel 40 is adjacent to the front panel 24 of the interior sleeve 20, the interior sleeve 20 is not held in place by the magnetic force enabling the interior sleeve 20 to slide out of the housing shell 12.

In an example, the magnetic panel 40 can include one or a plurality of magnets between the first side 42 and the second side 44. For example, a magnet having a first side polarity opposite of that from the second side polarity is positioned inside a cavity between the first side 42 and the second side 44, wherein a first side polarity of the magnet is flush against the first side 42, and the second side polarity of the magnet is flush against the second side 44.

Similarly, front panel 24 of the interior sleeve 20 can include one or a plurality of magnets within the front panel 24 such that the magnets are flush to an outer surface of the front panel 24 that is adjacent to and/or engages with the magnetic panel 40.

In an example, a single magnet can be positioned within the center of the magnetic panel 40. Alternatively, or in addition to, four or more magnets can be positioned within each corner of the magnetic panel 40. Similarly, the magnets within the front panel 24 of the interior sleeve 20 can have magnets configured in a way to match the configuration in the magnetic panel 40.

The magnetic source in the front panel 24 of the interior sleeve 20, the first side 42 of the magnetic panel 40, and the second side 44 of the magnetic panel 40 can be independently selected from any suitable magnetic source including a single magnet, a plurality of spaced magnets, a magnetic sheet, among others. Alternatively, the entire magnetic panel 40 can be one single sheet of magnet having a first polarity side and opposite second polarity side.

The magnetic source can be any suitable magnetic source. For example, conventional magnets can be used. The magnetic source can be any material that produces a magnetic field that pulls on other ferromagnetic materials, such as iron, and attracts and/or repels other magnets. The magnetic source can be ferromagnetic and/or ferromagnetic. The magnetic materials can include, but not limited to, iron, nickel, cobalt, alloys of rare-earth metals, and naturally occurring minerals such as iodestrone. In an example, the magnets used are nickel plated neodymium disc magnets, N42. The size and weight of the magnet can be dependent on the weight/size of the container and the weight/size of the content within the container. For example, for a light product, a ceramic disk magnet could be used, whereas for a heavier product, a rare earth magnet could be used.

The interior compartment 50 of the interior sleeve 20 can be any suitable configuration. As shown in FIG. 5, the interior compartment 50 can include a plurality of cavities 52 for holding individual doses and amounts. For example, the cavities can be suitable to hold doses of drugs, chemicals, pharmaceuticals, food, etc. The cavities 52 can be designed to house solids, liquid, gels, among others.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

We claim:

1. A container comprising:
a housing shell including a first end and second end;
an interior sleeve positioned within the housing shell, wherein the interior shell includes an interior cavity, wherein the interior shell includes a front panel having a magnetic polarity; and
a magnetic panel replaceably positioned within the first end of the housing shell, wherein the magnetic panel is adjacent to the front panel of the interior sleeve, wherein the magnetic panel includes a first side and a second side, wherein the second side has an opposite magnetic polarity of the front panel,
wherein when the second side of the magnetic panel is adjacent to the front panel, the interior sleeve is prevented from sliding out of the housing shell,
wherein when the second side of the magnetic panel is not adjacent to the front panel, the interior sleeve is not prevented from sliding out of the housing shell.

2. The container of claim 1, wherein when the first side of the magnetic panel is adjacent to the front panel, the interior sleeve is not prevented from sliding out of the housing shell.

3. The container of claim 1, wherein the housing shell includes a top panel, a bottom panel, and two side panels connecting the top panel to the bottom panel.

4. The container of claim 1, wherein the interior shell includes a bottom panel, two side panels extending from the bottom panel, and a back panel opposite of the front panel.

5. The container of claim 1, wherein the magnetic panel includes at least one finger opening portion within at least one edge of the magnetic panel.

6. The container of claim 1, wherein the first side of the magnetic panel includes a magnetic polarity opposite of the magnetic polarity of the front panel.

7. The container of claim 1, wherein the front panel of the interior sleeve includes a plurality of magnets.

8. The container of claim 1, wherein the second side of the magnetic panel includes a plurality of magnets.

9. The container of claim 1, wherein the front panel of the interior sleeve includes a plurality of front magnets, wherein the second side of the magnetic panel includes a plurality of panel magnets, wherein the plurality of the front magnets are attracted to the plurality of panel magnets.

10. The container of claim 1, wherein the interior sleeve includes an interior cavity.

11. The container of claim 1, wherein the interior sleeve includes an interior cavity, wherein the interior cavity includes a plurality of dose compartments.
